(19) United States
(12) Patent Application Publication
(10) Pub. No.: US 2009/0092922 A1
(43) Pub. Date: Apr. 9, 2009

(54) Imaging Layers, Structures Including Imaging Layers, Methods of Making Imaging Layers, and Imaging Systems

(76) Inventors: Mehrgan Khavari, Corvallis, OR (US); Susan E. Bailey, Corvallis, OR (US); Paul Felice Reboa, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/868,996

(22) Filed: Oct. 9, 2007

(51) Int. Cl. B41M 5/136; G03C 5/00; G21K 5/00

(52) U.S. Cl. 430/270.15; 250/492.1; 430/328

(57) ABSTRACT

Imaging layers, image recording media, and methods of preparation of each, are disclosed.

### BACKGROUND

Compositions that produce a color change upon exposure to energy in the form of light are of great interest in producing images on a variety of substrates. For example, labeling of optical storage media such as Compact Discs, Digital Video Discs or Blue Laser Discs (CD, DVD, or Blue Laser Disc) can be routinely accomplished through screen-printing methods. While this method can provide a wide variety of label content, it tends to be cost ineffective for run lengths less than 300-400 discs because the fixed cost of unique materials and set-up are shared by all the discs in each run. In screen-printing, a stencil of the image is prepared, placed in contact with the disc and then ink is spread by squeegee across the stencil surface. Where there are openings in the stencil the ink passes through to the surface of the disc, thus producing the image. Preparation of the stencil can be an elaborate, time-consuming and expensive process.

In recent years, significant increases in use of CD/DVD discs as a data distribution vehicle have increased the need to provide customized label content to reflect the data content of the disc. For these applications, the screen-label printing presents a dilemma as discs are designed to permit customized user information to be recorded in standardized CD, DVD, or Blue Laser Disc formats. Today, for labeling small quantities of discs, popular methods include hand labeling with a permanent marker pen, using an inkjet printer to print an adhesive paper label, and printing directly with a pen on the disc media which has a coating that has the ability to absorb inks. The hand printing methods do not provide high quality and aligning a separately printed label by hand is inexact and difficult.

It may therefore be desirable to design an optical data recording medium (e.g., CD, DVD, or Blue Laser Disc) which can be individually labeled by the user easily and inexpensively relative to screen-printing while giving a high quality label solution. It may also be desirable to design an optical data recording medium that accepts labeling via multiple methods, thus reducing the amount of inventory necessarily carried by optical data recording merchants and end users.

### SUMMARY

Briefly described, embodiments of this disclosure include imaging layers, image recording media, methods of making each, methods of forming an image on an imaging layer, imaging system, and the like.

One exemplary embodiment of imaging layer, among others, includes: a substrate having an imaging layer disposed thereon, wherein the imaging layer includes: a matrix; a near-infrared radiation-absorbing compound, wherein the near-infrared radiation-absorbing compound is bleached when exposed to radiation from about 280 to 480 nm; an activator; and a color former.

One exemplary embodiment of an optical disk, among others, includes: imaging layer that includes: a matrix; a near-infrared radiation-absorbing compound, wherein the near-infrared radiation-absorbing compound is bleached when exposed to radiation from about 280 to 480 nm; an activator; and a color former.

One exemplary embodiment of a method for preparing a recording medium, among others, includes: providing a matrix, a near-infrared radiation-absorbing compound, wherein the near-infrared radiation-absorbing compound is bleached when exposed to radiation from about 280 to 480 nm, an activator, and a color former; mixing the radiation-absorbing compound, the activator, and the color former, in the matrix to form a matrix mixture; and disposing the matrix mixture onto a substrate to form the imaging layer.

One exemplary embodiment of a method of forming an image on an imaging layer, among others, includes: providing a structure including an imaging layer, wherein the imaging layer includes a matrix, a near-infrared radiation-absorbing compound, wherein the near-infrared radiation-absorbing compound is bleached when exposed to radiation from about 280 to 480 nm, an activator, and a color former; exposing the structure to a first radiation energy from a first irradiation system, wherein the first radiation energy forms an image in the imaging layer; and exposing the structure to a second radiation energy from a second irradiation system, wherein the second radiation energy bleaches the near-infrared radiation-absorbing compound.

One exemplary embodiment of an imaging system, among others, includes: a computer control system, a first irradiation system, and a second irradiation system, wherein the first irradiation system emits radiation at about 780 nm or about 650 nm, and wherein the second irradiation system emits radiation at about 280 to 480 nm.

### BRIEF DESCRIPTION OF THE DRAWINGS

Many aspects of this disclosure can be better understood with reference to the following drawings. The components in the drawings are not necessarily to scale. Moreover, in the drawings, like reference numerals designate corresponding parts throughout the several views.

FIG. 1 illustrates an embodiment of an imaging medium.

FIG. 2 illustrates a representative embodiment of a print system.

FIG. 3 illustrates two formula of representative styryl dyes.

### DETAILED DESCRIPTION

Embodiments of the present disclosure will employ, unless otherwise indicated, techniques of synthetic organic chemistry, ink chemistry, media chemistry, and the like, that are within the skill of the art. Such techniques are explained fully in the literature.

The following examples are put forth so as to provide those of ordinary skill in the art with a complete disclosure and description of how to perform the methods and use the compositions disclosed and claimed herein. Efforts have been made to ensure accuracy with respect to numbers (e.g., amounts, temperature, etc.) but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the term “leuco-dye” means a color-forming substance that is colorless or of a first color in a non-activated state, and subsequently exhibits color or changes from the first color to a second color in an activated state.

As used herein, the term “activator” is a substance that reacts with a color former such as a leuco-dye, causing the leuco-dye to alter its chemical structure and change or acquire color.

As used herein, the term “antenna” is a radiation-absorbing compound. The antenna readily absorbs a desired specific wavelength of the marking radiation.

### Discussion

Embodiments of the disclosure include imaging layers, image recording media, methods of making each, methods of forming an image on an imaging layer, an imaging system, and the like. The image-recording medium includes an image layer or coating including, but not limited to, a matrix, a color former, an activator, and a near-infrared radiation-absorbing compound. Using near-infrared radiation-absorbing compounds can be problematic because they have poor light fast resistance (e.g., becomes unstable). The rapid lightfade of the near-infrared radiation-absorbing compound when exposed to ambient daylight or office lighting conditions is related to their capability to absorb radiation in the blue and near UV region of the spectrum (about 350 to 500 nm). In this regard, imaging layers can lose sensitivity to imaging laser radiation upon relatively short ambient daylight exposure because the near-infrared radiation-absorbing compound absorb radiation in the blue and near UV of the spectrum and fade. Fading of the near-infrared radiation-absorbing compound in the imaging layer leads to marking sensitivity loses in the image layer. However, the near-infrared radiation-absorbing compound more efficiently absorbs radiation emitted by the laser (e.g., a 780 nm laser operating at 35 mW) so that the imaging layer can be labeled about 1.5 to 2 times faster than if other radiation-absorbing compounds are used. Also, the poor light fast resistance properties of the near-infrared radiation-absorbing compound can be used advantageously by intentionally bleaching (e.g., causing the near-infrared radiation-absorbing compound to become decomposed or degraded) the near-infrared radiation-absorbing compounds using the imaging system after labeling the imaging layer. In this manner the color signature of the near-infrared radiation-absorbing compounds is removed to provide a better color background. In addition, the imaging layer is made tamper-proof since the near-infrared radiation-absorbing compound is eliminated.

The image layer can be a coating disposed onto a substrate and used in structures such as, but not limited to, paper, digital recording material, cardboard (e.g., packaging box surface), plastic (e.g., food packaging surface), and the like.

A clear mark and excellent image quality can be obtained by directing radiation energy (e.g., a 780 nm laser operating at 35 mW) at areas of the image layer on which a mark is desired. As mentioned above, the components in the image layer used to produce the mark via a color change upon stimulation by energy can include, but is not limited to, the matrix, the color former (e.g., a leuco dye), the activator, and the near-infrared radiation-absorbing compound. In an embodiment, the components can be dissolved into a matrix material. In another embodiment, one or more components can be insoluble or substantially insoluble in the matrix material at ambient temperatures, where the components are uniformly dispersed throughout the matrix material.

In an embodiment, when the near-infrared radiation-absorbing compound absorbs a defined radiation energy, the heat generated from the near-infrared radiation-absorbing compound allows a reaction between the color former and the activator to occur and to produce a color change (e.g., a mark). After the label is formed on the imaging layer, the structure or the structure including the imaging layer is exposed to a light source that emits radiation that bleaches the near-infrared radiation-absorbing compound. As mentioned above, the color signature of the near-infrared radiation-absorbing compound is removed and the imaging layer is made tamper-proof (can not be imaged on).

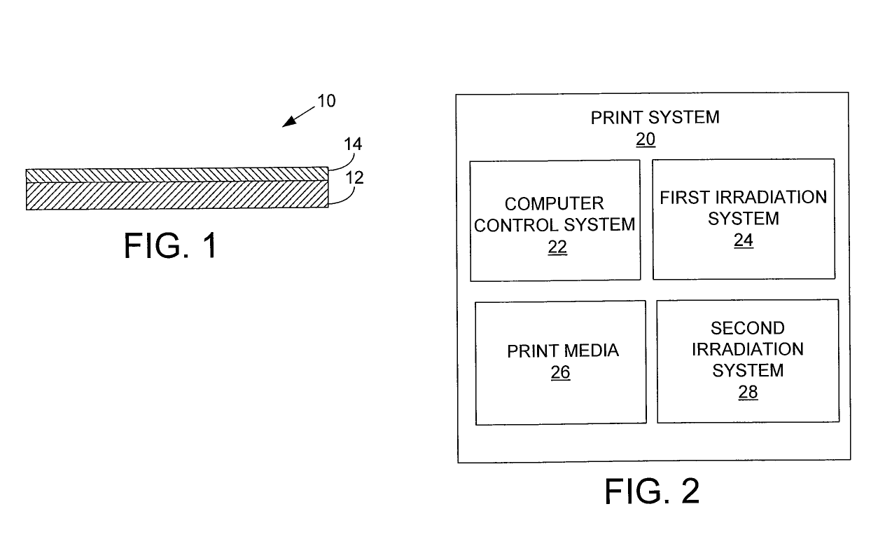

FIG. 1 illustrates an embodiment of an imaging medium 10. The imaging medium 10 can include, but is not limited to, a substrate 12 and an imaging layer 14 (e.g., that includes near-infrared radiation-absorbing compounds). The substrate 12 can be a substrate upon which it is desirable to make a mark, such as, but not limited to, paper (e.g., labels, tickets, receipts, or stationery), overhead transparencies, a metal/metal composite, glass, a ceramic, a polymer, and a labeling medium (e.g., a compact disk (CD) (e.g., CD-R/RW/ROM) and a digital video disk (DVD) (e.g., DVD-R/RW/ROM)).

In particular, the substrate 12 includes an “optical disk” which is meant to encompass audio, video, multi-media, and/or software disks that are machine readable in a CD and/or DVD drive, or the like. Examples of optical disk formats include writeable, recordable, and rewriteable disks such as DVD, DVD-R, DVD-RW, DVD+R, DVD+RW, DVD-RAM, CD, CD-ROM, CD-R, CD-RW, DVD-HD, Blu-ray, and the like. Other like formats can also be included, such as similar formats and formats to be developed in the future.

The imaging layer 14 can include, but is not limited to, the matrix, the color former, the activator, the near-infrared radiation-absorbing compound, as well as other components typically found in the particular media to be produced.

The imaging layer 14 may be applied to the substrate 12 via any acceptable method, such as, but not limited to, rolling, spraying, and screen-printing. In addition, one or more layers can be formed between the imaging layer 14 and the substrate 12 and/or one or more layer can be formed on top of the imaging layer 14. In one embodiment, the imaging layer 14 is part of a CD or a DVD.

To form a mark, radiation energy is directed imagewise at one or more discrete areas of the imaging layer 14 of the imaging medium 10. The form of radiation energy may vary depending upon the equipment available, ambient conditions, the desired result, and the like. The radiation energy can include, but is not limited to, infrared (IR) radiation, ultraviolet (UV) radiation, x-rays, and visible light. In an embodiment the radiation can be 780 nm or 650 nm as to correspond to the laser wavelength to be used to image the coating. The near-infrared radiation-absorbing compound absorbs the radiation energy and heats the area of the imaging layer 14 to which the radiation energy impacts. The heat may cause the color former and the activator to mix. The color former and the activator may then react to form a mark (color) on certain areas of the imaging layer 14. Subsequently, the imaging layer 14 is exposed to a light source that emits radiation that bleaches the near-infrared radiation-absorbing compound.

FIG. 2 illustrates a representative embodiment of a print system 20. The print system 20 can include, but is not limited to, a computer control system 22, a first irradiation system 24, print media 26 (e.g., imaging medium), and a second irradiation system 28. The computer control system 22 is operative to control the first and the second irradiation systems 24 and 28 to cause marks (e.g., printing of characters, symbols, photos, and the like) to be formed on the print media 26 and to bleach the near-infrared radiation-absorbing compound, respectively. The first irradiation system 24 can include, but is not limited to, a laser system, UV energy system, IR energy system, visible energy system, x-ray system, and other systems that can produce radiation energy to cause a mark to be formed on the imaging layer 14. The print system 20 can include, but is not limited to, a laser printer system and an ink-jet printer system. In addition, the print system 20 can be incorporated into a digital media system. For example, the print system 20 can be operated in a digital media system to print labels (e.g., the layer is incorporated into a label) onto digital media such as CDs and DVDs. Furthermore, the print system 20 can be operated in a digital media system to directly print onto the digital media (e.g., the layer is incorporated the structure of the digital media).

The second irradiation system 28 can include an irradiation source capable of bleaching the near-infrared radiation-absorbing compound in the imaging layer. In this regard, the second irradiation system 28 can include, but is not limited to, an irradiation source emitting from about 280 to 480 nm, about 360 to 480 nm, and 395 to 480 nm. The source of the radiation can include, but is not limited to, a Mercury arc lamp, a fluorescence bulb, an UV LEDs, a laser, combinations thereof, and the like. The exposure time (e.g., a few seconds to a minute or more) of the imaging layer to the second irradiation system 28 depends, at least in part, upon the irradiation source and the concentration of the near-infrared radiation-absorbing compound in the imaging layer. The second irradiation system 28 can have a fixed source (e.g., the structure including the imaging layer moves) or can have a movable source (e.g., the structures does not move but the source moves relative to the structure).

As mentioned above, the imaging layer includes, but is not limited to, the matrix, the color former, the activator, and the near-infrared radiation-absorbing compound. The near-infrared radiation-absorbing compound is bleached (decomposes or degrades) upon exposure to radiation for about 280 to 480 nm, about 360 to 480 nm, and 395 to 480 nm. For example exposure of a circular area with a 25 mm diameter to a UV LED source emitting 380 to 420 nm at a 1 W/cm̂² power output at a distance of 2 mm away form the surface results in a bleach time of 15 to 20 seconds. The term “bleach” or “bleaches” can include decomposition or degradation of the near-infrared radiation-absorbing compound such that the near-infrared radiation-absorbing compound ceases to function as a near-infrared radiation-absorbing compound. The near-infrared radiation-absorbing compound has an extinction coefficient of about 2 to 4×10⁴ L/mol cm at 780 nm.

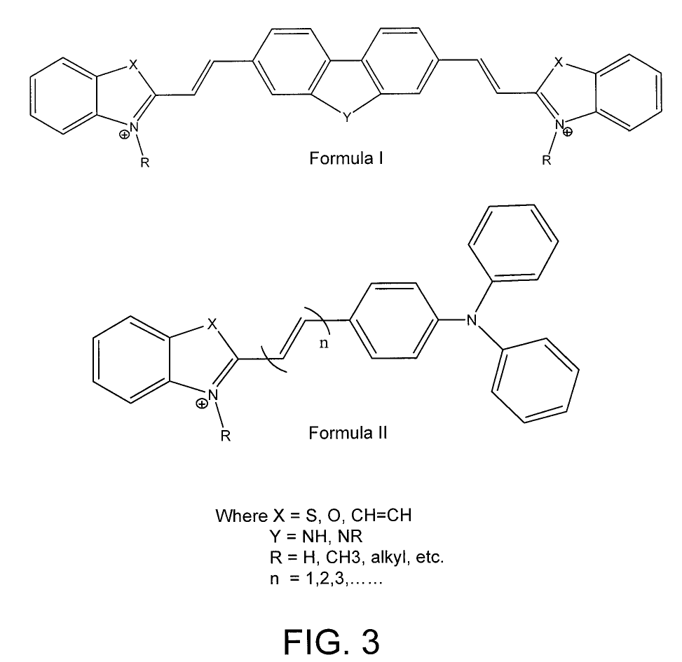

The near-infrared radiation-absorbing compound includes, but is not limited to, croconium dyes (also called “dioxo” or “oxanol”) (e.g., 3-(2-Piperidino-thien-2yl)-5(2,5-dihydro-4-methyl-2-[piperidin-1-ylidene-onium]-thien-5-ylidene)-,2-dioxo-cyclopenten-4-olate and other dyes based on the 1,2-dioxo-cyclopenten-olate sub-structure), indolium dyes, part of cyanine family, (e.g., IR-786 (2-(2-[2-chloro-3-([1,3-dihydro-1,3,3-trimethyl-2H-indol-2-ethylidene)-1-cyclohexen-1-yl]ethenyl)-1,3,3-trimethylindolium perchlorate) and IR-780 (2-(2-[2-Chloro-3-[2-(3,3-dimethyl-1-propyl-1,3-dihydro-indol-2-ylidene)-ethylidene]-cyclohex-1-enyl]-vinyl)-3,3-dimethyl-1-propyl-3H-indolium iodide) (CAS 207399-07-3) and salts of each), squarillium dyes, based on cyclobutenediylium (e.g., 2,4-Di-3-guaiazulenyl-1,3-dihydroxycyclobutenediylium dihydroxide bis(inner salt)4), cyanine dyes (e.g., 10-Acetoxy-1,1′-bis(4-sulfobutyl)-4,5:4′,5′-dibenzo-3,3,3′,3′-tetramethylindatricarbocyanine betaine sodium salt and other counter ion salts), styryl dyes (e.g., Formula I and II in FIG. 3). Additional examples include 650 nm absorbing compounds such as 3-Ethyl-2-[5-(3-ethyl-2-benzothiazolinylidene)-1,3-pentadienyl]benzothiazolium iodide, 1,1′-Dibutyl-3,3,3′,3′-tetramethylindodicarbocyanine perchlorate, 1,1′-Dibutyl-3,3,3′,3′-tetramethylindadicarbocyanine hexafluorophosphate. In an embodiment, the imaging layer only includes the near-infrared radiation-absorbing compound and does not include any other radiation-absorbing compounds.

The near-infrared radiation-absorbing compound can be about 0.05 to 5 wt % of the imaging layer, about 0.1 to 3 wt % of the imaging layer, and about 0.5 to 2 wt % of the imaging layer.

The matrix can include compounds capable of and suitable for dissolving and/or dispersing the radiation absorbing compound, the activator, and/or the color former. The matrix can include, but is not limited to, UV curable monomers, oligomers, and pre-polymers (e.g., acrylate derivatives. Illustrative examples of UV-curable monomers, oligomers, and pre-polymers (that may be mixed to form a suitable UV-curable matrix) can include but are not limited to, hexamethylene diacrylate, tripropylene glycol diacrylate, lauryl acrylate, isodecyl acrylate, neopentyl glycol diacrylate, 2-phenoxyethyl acrylate, 2(2-ethoxy)ethylacrylate, polyethylene glycol diacrylate and other acrylated polyols, trimethylolpropane triacrylate, pentaerythritol tetraacrylate, ethoxylated bisphenol A diacrylate, acrylic oligomers with epoxy functionality, and the like.

In an embodiment the matrix is used in combination with a photo package. A photo package may include, but is not limited to, a light absorbing species (photoinitiators), which initiates reactions for curing of a matrix such as, by way of example, benzophenone derivatives. Other examples of photoinitiators for free radical polymerization monomers and pre-polymers include, but are not limited to, thioxanethone derivatives, anthraquinone derivatives, acetophenones and benzoine ether types, and the like.

It may be desirable to choose a matrix that is cured by a form of radiation other than the type of radiation that causes a color change. Matrices based on cationic polymerization resins may include photo-initiators based on aromatic diazonium salts, aromatic halonium salts, aromatic sulfonium salts and metallocene compounds, for example. An example of a matrix may include Nor-Cote CDG000. Other acceptable matrices may include, but is not limited to, acrylated polyester oligomers (e.g., CN293 and CN294, available from Sartomer Co.).

The matrix compound is about 2 to 98 wt % of the imaging layer and about 20 to 90 wt % of the imaging layer.

As mentioned above, color formers can be included in the coating layer. The color formers can include, but are not limited to, leuco dyes and phthalide color formers (e.g., fluoran leuco dyes and phthalide color formers as described in “The Chemistry and Applications of Leuco Dyes”, Muthyala, Ramiah, ed., Plenum Press (1997) (ISBN 0-306-45459-9), which is incorporated herein by reference).

The color forming composition can include, but is not limited to, a wide variety of leuco dyes. Suitable leuco dyes include, but are not limited to, fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(p-hydroxyphenyl)-4,5-diphenylimidazoles, indanones, leuco indamines, hydrozines, leuco indigoid dyes, amino-2,3-dihydroanthraquinones, tetrahalo-p,p′-biphenols, 2(p-hydroxyphenyl)-4,5-diphenylimidazoles, phenethylanilines, phthalocyanine precursors (such as those available from Sitaram Chemicals, India), and other known leuco dye compositions. Experimental testing has shown that fluoran based dyes are one class of leuco dyes which exhibit particularly desirable properties.

In one aspect of the present disclosure, the leuco dye can be a fluoran, phthalide, aminotriarylmethane, or mixture thereof. Several non-limiting examples of suitable fluoran based leuco dyes include 3-diethylamino-6-methyl-7-anilinofluorane, 3-(N-ethyl-p-toluidino)-6-meth-yl-7-anilinofluorane, 3-(N-ethyl-N-isoamylamino)-6-methyl-7-anilinofluoran-e, 3-diethylamino-6-methyl-7-(o,p-dimethylanilino)fluorane, 3-pyrrolidino-6-methyl-7-anilinofluorane, 3-piperidino-6-methyl-7-anilino-fluorane, 3-(N-cyclohexyl-N-methylamino)-6-methyl-7-anilinofluorane, 3-diethylamino-7-(m-trifluoromethylanilino)fluorane, 3-dibutylamino-6-methyl-7-anilinofluorane, 3-diethylamino-6-chloro-7-anil-inofluorane, 3-dibutylamino-7-(o-chloroanilino)fluorane, 3-diethylamino-7-(o-chloroanilino)fluorane, 3-di-n-pentylamino-6-methyl-7-anilinofluoran, 3-di-n-butylamino-6-methyl-7-anilinofluoran, 3-(n-ethyl-n-isopentylamino)-6-methyl-7-anilinofluoran, 3-pyrrolidino-6-methyl-7-anilinofluoran, 1(3H)-isobenzofuranone,4,5,6,7-t-etrachloro-3,3-bis[2-[4-(dimethylamino)phenyl]-2-(4-methoxyphenyl)ethenyl]-,2-anilino-3-methyl-6-(N-ethyl-N-isoamylamino)fluorane (S-205 available from Nagase Co., Ltd), and mixtures thereof.

Suitable aminotriarylmethane leuco dyes can also be used in embodiments of the preset disclosure, such as tris(N,N-dimethylaminophenyl)methane (LCV), tris(N,N-diethylaminophenyl) methane (LECV), tris(N,N-di-n-propylaminophenyl)methane (LPCV), tris(N,N-di-n-butylaminophenyl) methane (LBCV), bis(4-diethylaminophenyl)-(4-diethylamino-2-methyl-phenyl)methane (LV-1), bis(4-diethylamino-2-methylphenyl)-(4-diethylamino-phenyl)methane (LV-2), tris(4-diethylamino-2-methylphenyl)methane (LV-3), bis(4-diethylamino-2-methylphenyl)(3,4-dimethoxy-phenyl)methane (LB-8), aminotriarylmethane leuco dyes having different alkyl substituents bonded to the amino moieties wherein each alkyl group is independently selected from C1-C4 alkyl, and aminotriaryl methane leuco dyes with any of the preceding named structures that are further substituted with one or more alkyl groups on the aryl rings wherein the latter alkyl groups are independently selected from C1-C3 alkyl. Other leuco dyes can also be used in connection with the present invention and are known to those skilled in the art. A more detailed discussion of some of these types of leuco dyes may be found in U.S. Pat. Nos. 3,658,543 and 6,251,571, each of which are hereby incorporated by reference in their entireties. Additional examples and methods of forming such compounds can be found in Chemistry and Applications of Leuco Dyes, Muthyala, Ramaiha, ed., Plenum Press, New York, London, ISBN: 0-306-45459-9, which is hereby incorporated by reference.

The color former can be about 3 to 35 wt % of the imaging layer, about 10 to 30 wt % of the imaging layer, and about 10 to 20 wt % of the imaging layer.

As used herein, the term “activator” is a substance that reacts with a color former and causes the color former to alter its chemical structure and change or acquire color. The activator can include a compound that has an acid such as, but not limited to, a Lewis acid that has a functionality such as a complexed transition metal, metal salt, phenolic compound, and combinations thereof, and can be reactive with leuco dyes with or without introduction of energy in the form of light and/or heat. In particular, the activators may include, but is not limited to, proton donors and acidic phenolic compounds (e.g., benzyl hydroxybenzoate, bisphenol-A and bisphenol-S) as well as derivatives thereof (e.g., D8™ (4-hydroxyphenyl-4′-isopropoxyphenyl sulfone), TG-SA™ (bis(4-hydroxy-3-allylphenyl) sulfone), polyphenols, and sulfonylurea and derivatives thereof.

The activator is from about 2 to 50 wt % of the imaging layer and, preferably, from about 5 to 35 wt % of the imaging layer.

The crosslinking agent can include, but is not limited to, aldehyde compounds (e.g., formaldehyde, glyoxal and glutaraldehyde); ketone compounds (e.g., diacetyl and cyclopentanedione); active halogen compounds (e.g., bis(2-chloroethylurea)-2-hydroxy-4,6-dichloro-1,3,5-triazine and 2,4-dichloro-6-s-triazine sodium salt); active vinyl compounds (e.g., divinyl sulfonic acid, 1,3-vinylsulfonyl-2-propanol, N,N′-ethylene-bis(vinylsulfonylacetamide), and 1,3,5-triacryloyl-hexahydr-o-s-triazine); N-methylol compounds (e.g., dimethylolurea and methyloldimethylhydantoin); melamine resins (e.g., methylolmelamine and alkylated methylolmelamine); epoxy resins; isocyanate compounds (e.g., 1,6-hexamethylenediisocyanate); aziridine compounds disclosed in U.S. Pat. Nos. 3,017,280 and 2,983,611; carboxyimide compounds disclosed in U.S. Pat. No. 3,100,704 which are incorporated herein by reference; epoxy compounds (e.g., glycerol triglycidyl ether); ethyleneimino compounds (e.g., 1,6-hexamethylene-N,N′-bis-ethyleneurea); halogenated carboxyaldehyde compounds (e.g., mucochloric acid and mucophenoxychloric acid); dioxane compounds (e.g., 2,3-dihydroxydioxane); metal-containing compounds (e.g., titanium lactate, aluminum sulfate, chromium alum, potassium alum, zirconyl acetate and chromiumacetate); polyamine compounds (e.g., tetraethylenepentamine); hydrazide compounds (e.g., adipic dihydrazide); and low molecular weight compounds and polymers having 2 or more oxazoline groups.

The crosslinking agent can be about 0.5 to 2 wt % of the imaging layer, about 0.2 to 1 wt % of the imaging layer, and about 0.2 to 0.75 wt % of the imaging layer.

Surfactants can also be present, such as alkyl polyethylene oxides, alkyl phenyl polyethylene oxides, polyethylene oxide (PEO) block copolymers, acetylenic PEO, PEO esters, PEO amines, PEO amides, and dimethicone copolyols. If used, such surfactants can be about 0.5 to 5 wt % of the imaging layer, about 0.5 to 2.5 wt % of the imaging layer, and about 0.5 to 1 wt % of the imaging layer.

In an embodiment, the imaging layer can include, but is not limited to, a matrix (about 40 to 65 wt % of the imaging layer), a color former (about 18 to 25 wt % of the imaging layer), an activator (about 10 to 20 wt % of the imaging layer), near-infrared radiation-absorbing compound (about 0.5 to 2 wt % of the imaging layer), photoinitiator (about 5 to 10 wt % of the imaging layer), and surface additives (about 0.5 to 3 wt % of the imaging layer).

While embodiments of the present disclosure are described in connection with the Examples and the corresponding text and figures, there is no intent to limit the disclosure to the embodiments in these descriptions. On the contrary, the intent is to cover all alternatives, modifications, and equivalents included within the spirit and scope of embodiments of the present disclosure.

### EXAMPLE 1

Table 1 illustrates an embodiment of a imaging layer formulation.

TABLE 1

| | wt % | Example compounds |
|---|---|---|
| UV-curable Lacquer | 51 | e.g., Lacquer XP 155/049-10 (Nor-Cote) |
| (Matrix) | | |
| Color former | 25 | e.g., BK400 or ODB-2 |
| (Lueco dye) | | |
| Activator | 15 | e.g., SDP, D8, TGSA, YSR |
| Photoinitiator | 7 | e.g., Irgacure 1300, 379, 651 (Ciba) |
| IR absorbing dye | 1 | e.g., IR 780 |
| Surface additives | 1 | e.g., Foamblast 20F (Lubrizol) |
| | 100 | |

### EXAMPLE 2

Table 2 illustrates an embodiment of an imaging layer formulation.

TABLE 2

| | wt % | Example compounds |
|---|---|---|
| UV-curable Lacquer | 51 | e.g., Mixtures of UV-curable acylate |
| (matrix) | | monomers (see Table 3) |
| Color former (Lueco dye) | 25 | e.g., BK400 or ODB-2 |
| Activator | 15 | e.g., SDP, D8, TGSA, YSR |
| Photoinitiator | 7 | e.g., Irgacure 1300, 379, 651 (Ciba) |
| IR absorbing dye | 1 | e.g., IR 780 |
| Surface additives | 1 | e.g., Foamblast 20F (Lubrizol) |
| | 100 | |

Table 3 illustrates an embodiment of a mixture that can be used as the matrix.

TABLE 3

| | |
|---|---|
| Hexanediol diacrylate | 15 |
| Isobornyl acrylate | 15 |
| Bisphenol-based epoxy diacrylate Oligomer | 13 |
| Tripropyleneglycol diacrylate | 4 |
| Methyl methacrylate, butyl methacrylate copolymer | 4 |
| Total | 51 |

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to ‘y’” includes “about ‘x’ to about ‘y’”. The term “consisting essentially of” is defined to include an imaging layer that includes the near-infrared radiation-absorbing compound specifically mentioned as well as other components (e.g., matrix, color former, activator, and the like), while not including other radiation-absorbing compounds not specifically mentioned in the formulation.

Many variations and modifications may be made to the above-described embodiments. All such modifications and variations are intended to be included herein within the scope of this disclosure and protected by the following claims.

At least the following is claimed:

1. An imaging layer comprising:
a substrate having an imaging layer disposed thereon, wherein the layer includes:
a matrix;
a near-infrared radiation-absorbing compound, wherein the near-infrared radiation-absorbing compound is bleached when exposed to radiation from about 280 to 480 nm;
an activator; and
a color former.

2. The imaging layer of claim 1, wherein near-infrared radiation-absorbing compound is a croconium dye.

3. The imaging layer of claim 1, wherein near-infrared radiation-absorbing compound is an indolium dye.

4. The imaging layer of claim 1, wherein near-infrared radiation-absorbing compound is a squarillium dye.

5. The imaging layer of claim 1, wherein near-infrared radiation-absorbing compound is a styryl dye.

6. The imaging layer of claim 1, wherein near-infrared radiation-absorbing compound is a cyanine dye.

7. The imaging layer of claim 1, wherein the substrate is selected from a paper medium, a transparency, an optical data disc, a compact disk (CD), and a digital video disk (DVD).

8. The imaging layer of claim 1, wherein the substrate is an optical disk format selected from one the following: DVD-HD, Blu-ray, DVD, DVD-R, DVD-RW, DVD±R, DVD±RW, DVD-RAM, CD, CD-ROM, CD-R, and CD-RW.

9. The imaging layer of claim 1, wherein the substrate is selected from cardboard and plastic.

10. An optical disk comprising:
imaging layer that includes:
a matrix;
a near-infrared radiation-absorbing compound, wherein the near-infrared radiation-absorbing compound is bleached when exposed to radiation from about 280 to 480 nm;
an activator; and
a color former.

11. The optical disk of claim 10, wherein near-infrared radiation-absorbing compound is selected from a croconium dye, an indolium dye, squarillium dye, styryl dye, a cyanine dye, and combinations thereof.

12. The optical disk of claim 10, wherein the optical disk is selected from a compact disk (CD) and a digital video disk (DVD), DVD-HD, Blu-ray.

13. The optical disk of claim 10, wherein the optical disk is selected from one the following: DVD-HD, Blu-ray, DVD, DVD-R, DVD-RW, DVD+R, DVD+RW, DVD-RAM, CD, CD-ROM, CD-R, and CD-RW.

14. The optical disk of claim 10, wherein the optical disk stores digital data.

15. A method for preparing a recording medium, the method comprising:
providing a matrix, a near-infrared radiation-absorbing compound, wherein the near-infrared radiation-absorbing compound is bleached when exposed to radiation from about 280 to 480 nm, an activator, and a color former;
mixing the radiation-absorbing compound, the activator, and the color former, in the matrix to form a matrix mixture; and
disposing the matrix mixture onto a substrate to form the imaging layer.

16. The method of claim 15, wherein the substrate is selected from a paper medium, a transparency, a compact disk (CD), and a digital video disk (DVD), DVD-HD, Blu-ray.

17. The method of claim 15, wherein the substrate is an optical disk that stores digital data.

18. The method of claim 15, wherein the substrate is an optical disk format selected from one the following: DVD-HD, Blu-ray, DVD, DVD-R, DVD-RW, DVD+R, DVD+RW, DVD-RAM, CD, CD-ROM, CD-R, and CD-RW.

19. A method of forming an image on an imaging layer, comprising:
providing a structure including an imaging layer, wherein the imaging layer includes a matrix, a near-infrared radiation-absorbing compound, wherein the near-infrared radiation-absorbing compound is bleached when exposed to radiation from about 280 to 480 nm, an activator, and a color former;
exposing the structure to a first radiation energy from a first irradiation system, wherein the first radiation energy forms an image in the imaging layer; and
exposing the structure to a second radiation energy from a second irradiation system, wherein the second radiation energy bleaches the near-infrared radiation-absorbing compound.

20. The method of claim 19, wherein near-infrared radiation-absorbing compound is selected from a croconium dye, an indolium dye, squarillium dye, styryl dye, a cyanine dye, and combinations thereof.

21. An imaging system, comprising:
a computer control system, a first irradiation system, and a second irradiation system, wherein the first irradiation system emits radiation at about 780 nm or about 650 nm, and wherein the second irradiation system emits radiation at about 280 to 480 nm.
